(19) United States
(12) Patent Application Publication
(10) Pub. No.: US 2002/0077125 A1
(43) Pub. Date: Jun. 20, 2002

(54) Efficient CDMA earliest phase offset search for geo-location

(76) Inventor: Jason F. Hunzinger, Carlsbad, CA (US)

Correspondence Address: SCOTT C. HARRIS, Fish & Richardson P.C., Suite 500, 4350 La Jolla Village Drive, San Diego, CA, 92122, US

(21) Appl. No.: 10/029,580

(22) Filed: Dec. 20, 2001

Related U.S. Application Data
(60) Provisional application No. 60/257,206, filed on Dec. 20, 2000.

(51) Int. Cl. H04Q 7/20

(52) U.S. Cl. 455/456; 455/13.1

(57) ABSTRACT

A wireless communication system improves the speed at which geo-location searches can be done by strategically setting window sizes and offsets and by intelligently tracking earliest path timing.

### CROSS-REFERENCE TO RELATED APPLICATIONS

This application claims benefit of U.S. Provisional application Ser. No. 60/257,206, filed Dec. 20, 2000, the content of which is herein incorporated by reference in its entirety.

### TECHNICAL FIELD

This invention relates to wireless communication systems, and more particularly to providing a system that improves the Advanced Forward Link Trilateration (AFLT) measurements and results.

### BACKGROUND

Wireless communication systems may operate using fixed infrastructure equipment or in ad-hoc configurations. In fixed infrastructure models, wireless communication systems typically comprise a plurality of base stations and mobile stations that communicate using an over-the-air communication protocol using physical layer technologies such as Code Division Multiple Access (CDMA) technology. IS-95, Mobile Station-Base Station Compatibility Standard for Dual-Mode Wideband Spread Spectrum Cellular System, published in July 1993 is an example of such a protocol standard. CDMA uses digital spread spectrum techniques that are less susceptible to interference.

Wireless communications systems such as CDMA typically operate using a variety of channels. In CDMA, for example, channelization is accomplished using orthogonal or quasi-orthogonal codes. Different channels generally have different purposes. Common channels are used to communicate to a plurality of mobile stations or base stations at the same time while dedicated channels are typically used for communication to and from one mobile station.

Wireless communication systems are beginning to incorporate network-based and network-assisted location determination systems. Some wireless handsets have network assisted GPS capability. Some CDMA wireless handsets make use of the wireless communication signals themselves to perform location-related measurements such as in Enhanced Forward Link Trilateration (EFLT) or Advanced Forward Link Trilateration (AFLT) methods that use the difference in phase delays of wireless signals as input to location calculations. Other wireless communication systems, such as some telematics products incorporate stand-alone capabilities such as GPS. Wireless terminals without location capabilities may also have access to location related information. For example, the base station that a mobile station communicates with may have a unique identifier that identifies that particular base station to the mobile or signal conditions may be recognized from past observations. These types of information inherently identify the mobile station's general location as being the same as at some prior time.

Location information can be used to enable location-based services. Similarly, location-based services can be network or terminal based or distributed between wireless communication system entities. Distributed or network based services generally require active communication and use of wireless resources such as communication channels. For example, the TIA/EIA location protocol standard IS-801 enables network-assisted GPS via messaging over the CDMA wireless link between infrastructure and terminals. Such resources may be expensive, limited and have quality of service impacts on usage such as moderate or high latency.

A key issue for geo-location using CDMA signals is determination of the timing of the line-of-sight signal path from base station transmitter to mobile station receiver. The timing can be used to determine a distance since the speed of the signal is known to be the speed of light. Timing is determined at a mobile station by measuring the timing and phase of pilot signals transmitted from a base station. Mobile stations also use this timing for CDMA communication purposes.

The IS-95B standard, in section 6.1.5.1 states that “[i]f a mobile station time reference correction is needed, it shall be corrected no faster than ¼ chip (203.451 ns) in any 200 ms period and no slower than ⅜ PN chip (305.18 ns) per second.” This translates to maximum and minimum bounds on timing adjustment rates of 1.25 chips/s and 0.375 chips/s respectively. These rules are set so that the base station transceiver can track a mobile transmit signal, i.e., the Doppler is limited to a manageable level. For geo-location purposes, these rules need not apply.

While the objective of timing operations for CDMA communications is tracking the best signal(s) in the presence of fading and multipath, the primary objective for geo-location is identifying the current timing of the line-of-sight path. These objectives are clearly different and what is needed is a distinct system of timing determination for geo-location.

What is needed is a system of CDMA phase offsets for geo-location that is based on geo-location objectives.

### SUMMARY

The present invention provides a system for improving the speed at which geo-location searches can be done by strategically setting window sizes and offsets and by intelligently tracking earliest path or line-of-sight timing. More efficient geo-location line-of-sight or earliest path determination may be accomplished by governing tracking of later arriving paths by mobile station dynamics, and governing tracking of earlier arriving paths by cell size.

CDMA pilot phase measurements are inherently noisy. Tracking of the earliest multipath component is complicated by this fact. Tracking requirements are also different for CDMA pilot set maintenance, (i.e. maintenance of the bearer service), and geo-location operation. Rules for tracking the earliest path for CDMA are specified by the air-interface standard to guarantee compatibility between network and mobile stations. However, new rules are established for geo-location earliest path or line-of-sight path tracking and searching.

These and other features and advantages of the invention will become more apparent upon reading the following detailed description and upon reference to the accompanying drawings.

### DESCRIPTION OF DRAWINGS

FIG. 1 illustrates components of a wireless communication system appropriate for use with an embodiment of the invention.

FIG. 2 illustrates a pair of base stations where the cell coverage area radius is less than the cell separation.

FIG. 3 illustrates a pair of base stations where the cell coverage area radius is greater than the cell separation.

FIG. 4 illustrates a process for configuring geo-location parameters according to one embodiment of the invention.

FIG. 5 illustrates a search window limitation determination.

### DETAILED DESCRIPTION

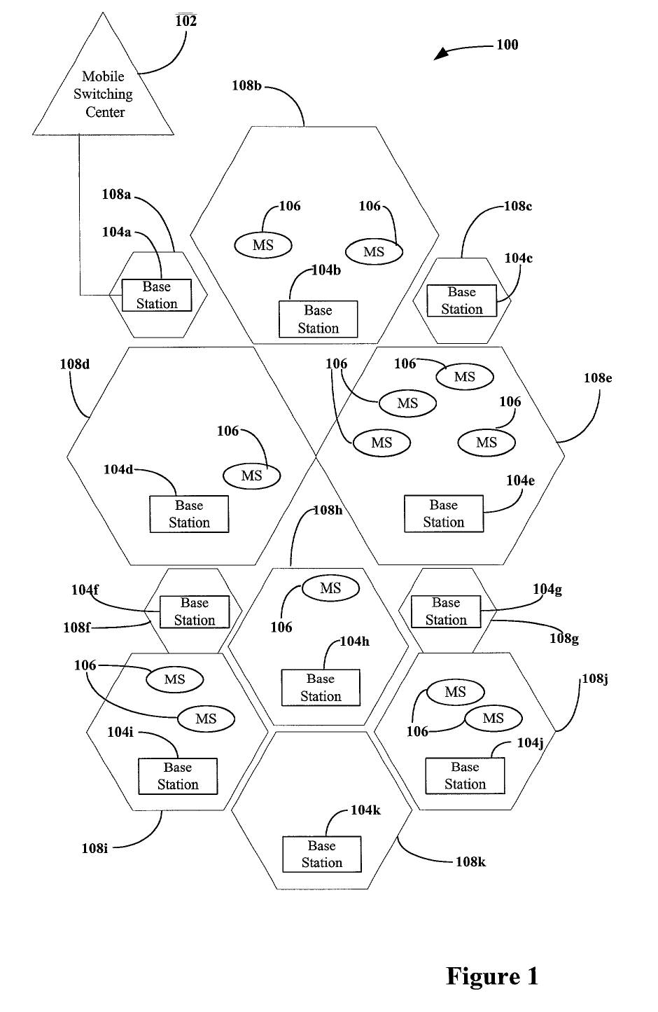

FIG. 1 illustrates components of an exemplary wireless communication system. A mobile switching center 102 communicates with base stations 104a-104k (only one connection shown). The base stations 104a-104k (generally 104) broadcasts data to and receives data from mobile stations 106 within cells 108a-108k (generally 108). The cell 108 is a geographic region, roughly hexagonal, having a radius of up to 35 kilometers or possibly more.

A mobile station 106 is capable of receiving data from and transmitting data to a base station 104. In one embodiment, the mobile station 106 receives and transmits data according to the Code Division Multiple Access (CDMA) standard. CDMA is a communication standard permitting mobile users of wireless communication devices to exchange data over a telephone system wherein radio signals carry data to and from the wireless devices.

Under the CDMA standard, additional cells 108a, 108c, 108d, and 108e adjacent to the cell 108b permit mobile stations 106 to cross cell boundaries without interrupting communications. This is so because base stations 104a, 104c, 104d, and 104e in adjacent cells assume the task of transmitting and receiving data for the mobile stations 106. The mobile switching center 102 coordinates all communication to and from mobile stations 106 in a multi-cell region. Thus, the mobile switching center 102 may communicate with many base stations 104.

Mobile stations 106 may move about freely within the cell 108 while communicating either voice or data. Mobile stations 106 not in active communication with other telephone system users may, nevertheless, scan base station 104 transmissions in the cell 108 to detect any telephone calls or paging messages directed to the mobile station 106.

One example of such a mobile station 106 is a cellular telephone used by a pedestrian who, expecting a telephone call, powers on the cellular telephone while walking in the cell 108. The cellular telephone scans certain frequencies (frequencies known to be used by CDMA) to synchronize communication with the base station 104. The cellular telephone then registers with the mobile switching center 102 to make itself known as an active user within the CDMA network.

When detecting a call, the cellular telephone scans data frames broadcast by the base station 104 to detect any telephone calls or paging messages directed to the cellular telephone. In this call detection mode, the cellular telephone receives, stores and examines paging message data, and determines whether the data contains a mobile station identifier matching an identifier of the cellular telephone. If a match is detected, the cellular telephone establishes a call with the mobile switching center 102 via the base station 104. If no match is detected, the cellular telephone enters an idle state for a predetermined period of time, then exits the idle state to receive another transmission of paging message data.

CDMA phase offsets may be used for geo-location purposes. The use of CDMA phase offsets for geo-location consists of computing a forward-link Trilateration solution. The phase tracking operation for geo-location purposes is based on mobile velocity and base station proximity. Faster tracking to earlier paths and slower tracking to later paths may be employed. Later paths are signal paths that follow a longer path and thus arrive at the mobile station later than other paths. The earliest path is typically a line-of-sight path which is a straight-line path from the transmitter to the receiver. In the present invention, tracking of the earliest path or line-of-sight path is of key interest for geo-location purposes. While there is no need to search for later paths for geo-location purposes, if the mobile is not stationary, the current earliest path may move. For example, if a cell phone user is driving directly away from the serving base station, then the line-of-sight path will be longer and the signal will arrive later. Therefore, to track that signal, the mobile station will likely have to search for the same path at a slightly later timing. Tracking of later paths is thus typically governed by dynamics, while earlier tracking is governed by cell size. Cell size dependencies will be discussed in detail below.

A reason for searching earlier than current path timings is to ensure detection of possible even earlier paths that may become receivable as the mobile station moves toward a base station. For example, if the current earliest path is not a line-of-sight path, then, as the mobile moves toward the base station, the direct line-of-sight path may become un-blocked and thus receivable. In other words, the mobile station should also take into account cases where the earliest received path is not the line-of-sight path. In such cases, it is possible for the mobile station to discover an earlier path (the line-of-sight path or other earlier path). This is the reason why tracking earlier is governed ultimately by cell size and the environment.

For geo-location, the maximum tracking rate determination for the line-of-sight path is more accurate if the mobile velocity is known, and in that case, it should be directly dependent on the mobile speed component in the direction away from/toward the base station in question. Mobile speed may also be used to predict the maximum even if the direction of the mobile is unknown. The determination may assume that the speed is in the direction away-from/toward the base station in question. The maximum, however, could be up to 0.1143 chips/s or more. At 100 KM/hr (or 28 m/s) heading directly toward or away from a base station antenna, a mobile station experiences a line-of-site path reference timing change rate of 0.11 chips/s (since the chip rate is 1.2288 MHZ, the chip duration is approximately 0.81 μs the rate is therefore the speed [m/s] divided by 243 meters per chip):

3×10⁸ m/s×0.81 μs/chip=243 m/chip

The tracking implementation, in terms of rate, is far less than the tracking limit imposed for the base station demodulation. The earliest path tracking is unlikely to track faster in the later direction than this limit implied by speed (in the direction of the base station) unless the path is not the line-of-sight path (i.e., an earlier path is discovered). On the other hand, line-of-sight path tracking earlier is not necessarily governed by the speed rule because as the mobile station moves toward a non-reference base station, the mobile station may likely discover earlier paths from other non-reference base stations. There is a limit, however, in this case due to the relative cell sizes and locations.

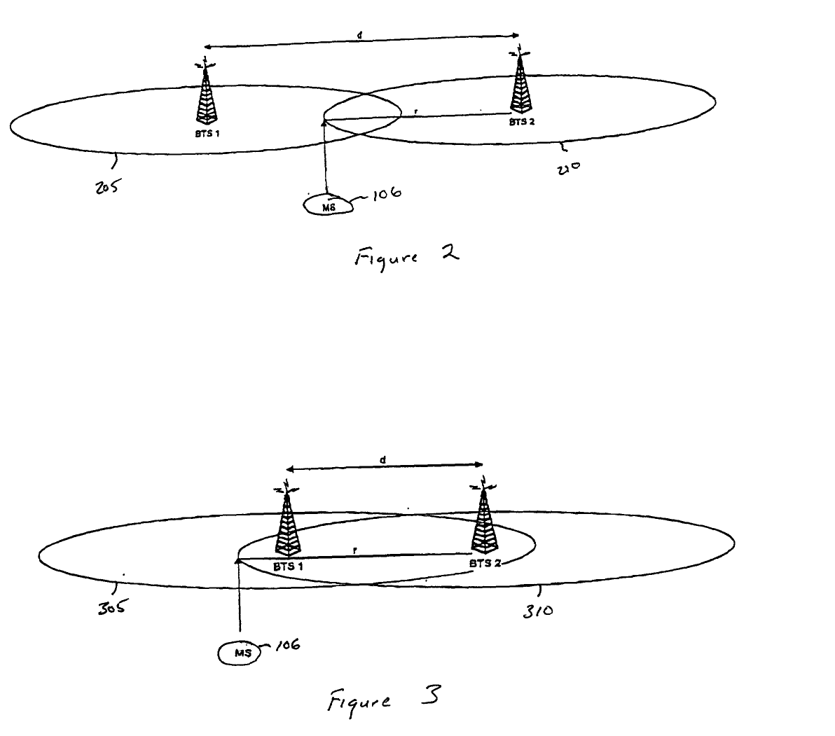

FIG. 2 illustrates a pair of base stations where the cell radius is less than the cell separation. In this two-dimensional model, where cell 205 is at (0,0) and cell 210 is distance d from cell 205 at (0,d). The difference in distance to the two cell centers from a mobile station 106 at (x,y) is:

Δd=(y²+x²)^{½}−(y²+(x−d)²)^{½}

Taking the derivative with respect to y and setting the results to 0 yields:

y(y²+x²)^{½}−y(y²+(x−d)²)^{½}=0

With this equation, there is only one solution which is y=0. The maximum distance difference, therefore, occurs when y=0. There are two possible cases: 1) the cell radius r is less than the cell separation d as in FIG. 2, and 2) the cell radius r is greater than or equal to the cell separation d as in FIG. 3.

In the situation presented in FIG. 2 where the cell radius r is less than the cell separation d:

Δd=[x−(d−x)]=(2x−d)

The maximum value of x is r, since if the mobile station is further from the cell, it will, by definition, not detect that cell. The maximum difference in distance is, therefore, at the cell border:

Δd=(2r−d);

And the maximum time difference is;

Δt=Δd/ct_{c}=(2r−d)/ct_{c};

The maximum value of which is d/ct_{c}, since in the situation presented in FIG. 2, the radius is less than the cell separation, or r<d.

When the cell radius is greater than or equal to the cell separation as illustrated in FIG. 3. In this example, cell 305 is at (0,0) and cell 310 is distance d from cell 205 at (0,d). The distance difference may be represented by;

Δd=[x−(x−d)]=d

And the maximum time difference is;

Δt=[x−(x−d)]/ct_{c}=d/ct_{c}.

In both cases, the maximum time difference is d/ct_{c}. For a 10 km cell radius, the resulting maximum time difference is 10 km/3.10⁸ m/s/0.81 μs=41 chips. This cell size based factor is used as input in determining the tracking or search parameters.

Cell size is important because it gives an indication of how far offset a PN phase can be from the reference PN earliest phase offset. When the mobile station searches for neighboring cells for CDMA communication purposes, it may use windows sizes up to several hundred chips in width or more. These windows are centered about the reference PN's timing (the earliest path observed arriving at the mobile station from the reference serving base station). That is, the timing of the primary serving sector's earliest arriving (detected) multi-path. For geo-location purposes, if it is known that the timing offset cannot be larger than some value, then there is no need to search further than that. For example, if the maximum timing offset is n chips, then the mobile station need only search n chips earlier and n chips later than the reference sector line-of-sight path timing (a total window size of 2n).

Tracking may be accomplished by periodic or continuous search for signals about a reference point. For convenience, the search window for geo-location purposes will be defined about the reference sector's earliest path. The size of the earlier side of the window (i.e. earlier timing than the reference sector's earliest path) is governed by the cell separation between the reference sector and another sector being searched for, such as a secondary serving sector or neighbor sector. The later side of the window (i.e. later timing that the reference sector's earliest path) is governed by the dynamics of the mobile station.

For example, if the reference time is defined as 0, without loss of generality, maximum offset limit due to dynamics is 40 chips per search period, maximum offset due to cell size is 40 chips, and a current neighbor earliest path timing is −10 chips relative to the reference time (i.e. earlier), then the smallest window is −40 to +30 chips (a size of 70 chips instead of 80 chips that would result from using cell size alone and instead of several hundred—a value that is typically used for CDMA communications). This clearly allows the mobile to complete geo-location searches faster.

The window may be further restricted the more line-of-sight path timings known for additional sectors or cells. In other words, if line-of-sight path timing is known for a number of sectors, that information may be used to further refine window size for searching for signals from a particular sector. The earliest offset that must be searched is the latest of the line-of-sight times (i.e. the timing of the line-of-sight path from the furthest base station known) minus the cell size based factor. Similarly, the latest offset that must be searched is the earliest line-of-sight (i.e. the timing of the line-of-sight from the closest base station known) plus the cell size based factor.

For example, consider the hypothetical case where the reference timing is defined as 0, without loss of generality, the earliest known path for a base station is 0 (the reference), and the latest known earliest path for a base station is +10 chips relative to the reference, and the maximum offset due to cell separation is 40 chips. In this case, there is no need to search earlier than −30 chips (10 minus 40) or later than +40 chips.

Since measurements are noisy, it is recommended that the windows be broadened to allow for a buffer against earliest path measurement error. The windows should be extended on either side by the uncertainty in whatever reference timing is used.

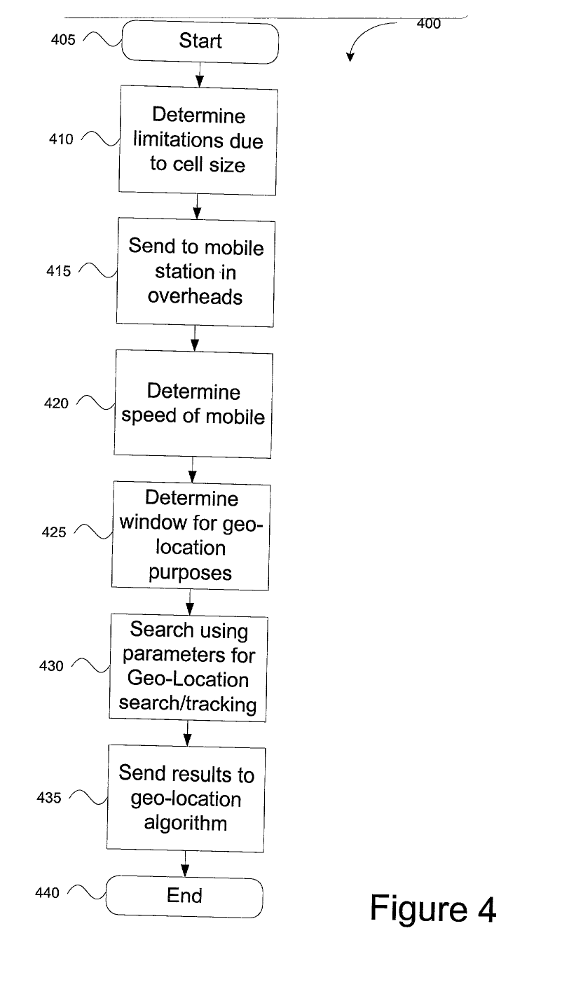

FIG. 4 illustrates a process 400 for configuring geo-location parameters according to one embodiment of the present invention. The process 400 begins in a START block 405. Proceeding to block 410, the process 400 determines the window limitations given cell coverage areas. Typically, this is done in the base station. In this case, the process proceeds to block 415 where the limitations are communicated to the mobile station 106. Typically this communication is done via overhead messages containing general information or via directed messaging for geo-location purposes. Next, in block 420, the mobile station determines its speed considerations. Typically, the speed of the mobile station 106 may be determined by the mobile station 106 itself. For example, the mobile station may have position location capability with which it can compute its change in position or velocity. Another example is where the mobile station may compute its estimated speed by evaluating the rate of change of pilot PN phase. In yet another embodiment speed may be assumed to be within a predetermined range. For example, one may assume that the maximum speed of a mobile station mounted in an automobile is 100 km/hr. For a fixed terminal, the maximum speed would be 0 m/s. The speed of the mobile station 106 is a major item that governs tracking for location, for the amount of a buffer that is needed is based on the speed of the mobile station 106.

Proceeding to block 425, the buffer size and offset are determined. As is stated above, the amount of the buffer is typically based on the speed or uncertainty of the speed of the mobile station 106 and the cell coverage area limitations communicated from the infrastructure. The mobile station may also use earliest path timing of other base stations as input to this determination. The mobile may determine these window sizes and offsets per base station. Proceeding to block 430, the search parameters for geo-location are set based on the window size and offset determinations and the search or tracking operation is executed to determine the measured earliest path offsets.

Proceeding to block 435, the mobile station 106 sends the geo-location search or tracking results to the positioning algorithm. The results may be used as inputs to Enhanced Forward Link Trilateration (EFLT) or Advanced Forward Link Trilateration position algorithms (AFLT). These results could also be used as inputs to augment the solution to a Global Positioning System (GPS) position determination. While the earliest path timing for a number of sectors, typically 3 or more, may be required to solve an AFLT or EFLT position location determination, fewer sectors may be used to augment a GPS solution. The process 400 then terminates in an END block 440.

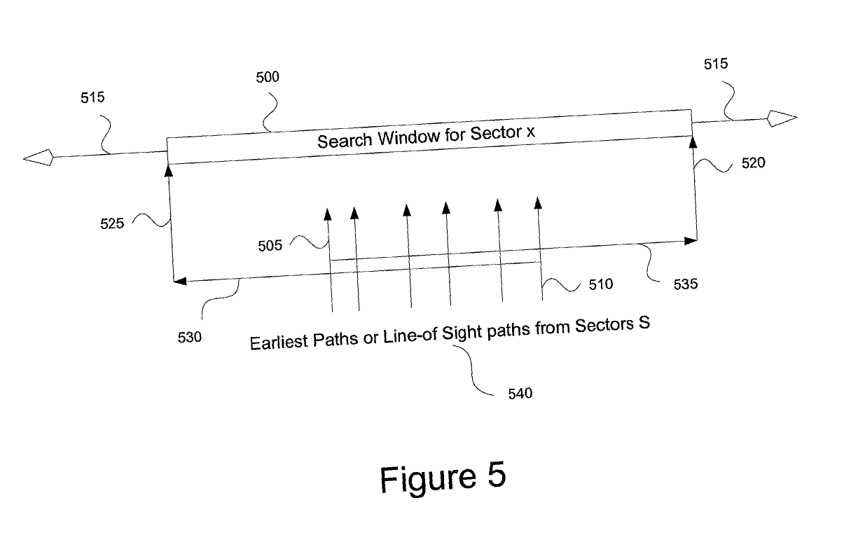

FIG. 5 illustrates a search window limitation determination. The search window 500 for a particular sector x may be determined based on earliest path or line of sight path timing of other sectors (from a set of sectors S) 540, cell size based factors and speed based factors. The double-ended axis 515 illustrated the phase offset reference axis. The earliest paths (which are likely to be line-of-sight paths) from each of the sectors in S are denoted 540. The earliest of these is 505 while the latest is 510. The latest point in the search window for sector x 500 pointed out by 520 may be determined as offset from the earliest path 505 by adding a cell size based factor or a speed factor or both 535. The operation of adding is meant to represent a delay from that earliest path timing 505. Similarly, the earliest point in the search window for sector x 500 pointed out by 525 may be determined as offset from the latest earliest path 510 by subtracting a cell size based factor or a speed factor or both 530. Note that the cell size based factors or speed factors may be generic across all sectors or different for each sector.

While IS-2000-A supports window sizes per neighbor, there is a) no capability to send a window offset to reflect cases where the mobile needs to search earlier rather that later or vice versa and b) no capability to specify a window size or offset for geo-location purposes, and c) no capability to set the tracking limits or recommendations. There is a need to be able to set window parameters separately for geo-location because unlike for CDMA bearer operation, focus is placed on earliest path measurements. Measurement of the non-earliest paths is not necessary for geo-location.

Although the present invention has been fully described in connection with the preferred embodiments thereof with reference to the accompanying drawings, it is to be noted that various changes and modifications will become apparent to those skilled in the art. Such changes and modifications are to be understood as being included within the scope of the present invention as defined by the appended claims.

What is claimed is:

1. A method of tracking earliest pilot phase offsets for geo-location determination comprising:
determining search window limitations for one or more sectors due to cell coverage area and due to mobile station dynamics; and
searching for earliest pilot phase offsets of the sectors using the determined search windows.

2. The method of claim 1, further comprising: determining search window offsets for each of the one or more sectors based on the relative phase offset between pilots of sectors.

3. The method of claim 1, wherein determining search window limitations further comprises determining an earliest point in time of the window as earlier than the latest of the line-of-sight or earliest path times from a set of sectors by a cell size based factor or speed based factor.

4. The method of claim 1, wherein determining search window limitations further comprises determining a latest point in time of the window as later than the earliest of the line-of-sight or earliest path times from a set of sectors by a cell size based factor or speed based factor.

5. The method of claim 1, further comprising setting the search window size asymmetrically from an early and a late side.

6. The method of claim 1, further comprising setting an early side of the search window based on cell size and speed of a mobile station.

7. The method of claim 1, further comprising setting a later side of the search window based on a speed of a mobile station.

8. The method of claim 1, further comprising transmitting cell size based limitations to a mobile station.

9. The method of claim 8, further comprising embedding the cell size based limitations in overheads or other messages.

10. The method of claim 1, further comprising using results of phase measurements in position location algorithms.

11. A mobile station for use in a wireless communication system comprising a processor which determines search window limitations for one or more sectors due to cell coverage area and due to the mobile station dynamics, wherein the mobile station searches for an earliest pilot phase offsets of the sectors using the determined search windows.

12. The mobile station of claim 11, wherein the processor determines search window offsets for each of the one or more sectors based on the relative phase offset between pilots of sectors.

13. The mobile station of claim 12, wherein the processor further determines search window limitations by determining an earliest point in time of the window as earlier than the latest of the line-of-sight or earliest path times from a set of sectors by a cell size based factor or speed based factor.

14. The mobile station of claim 12, wherein the processor further determines search window limitations by determining a latest point in time of the window as later than the earliest of the line-of-sight or earliest path times from a set of sectors by a cell size based factor or speed based factor.

15. The mobile station of claim 11, wherein the search window size is set asymmetrically from an early and a late side.

16. The mobile station of claim 11, wherein an early side of the search window is set based on cell size and speed of the mobile station.

17. The mobile station of claim 11, wherein a later side of the search window is set based on a speed of the mobile station.

18. The mobile station of claim 11, wherein the mobile station receives cell size based limitations.

19. The mobile station of claim 18, wherein the cell size based limitations are embedded in overheads or other messages.

20. The mobile station of claim 11, wherein the results of phase measurements are input to position location algorithms.

21. A wireless communication system which tracks earliest pilot phase offsets for geo-location determination comprising:
one or more base stations, each of the one or more base stations serving a cell divided into one or more sectors; and
a mobile station which determines search window limitations for the one or more sectors due to the cell coverage area and due to mobile station dynamics, wherein the mobile station searches for the earliest pilot phase offsets of the one or more sectors using the determined search windows.

22. The wireless communication system of claim 21, wherein the mobile station determines search window offsets for each of the one or more sectors based on the relative phase offset between pilots of sectors.

23. The wireless communication system of claim 22, wherein the mobile station further determines search window limitations by determining an earliest point in time of the window as earlier than the latest of the line-of-sight or earliest path times from a set of sectors by a cell size based factor or speed based factor.

24. The wireless communication system of claim 22, wherein the mobile station further determines search window limitations by determining a latest point in time of the window as later than the earliest of the line-of-sight or earliest path times from a set of sectors by a cell size based factor or speed based factor.

25. The wireless communication system of claim 21, wherein the search window size is set asymmetrically from an early and a late side.

26. The wireless communication system of claim 21, wherein an early side of the search window is set based on cell size and speed of the mobile station.

27. The wireless communication system of claim 21, wherein a later side of the search window is set based on a speed of the mobile station.

28. The wireless communication system of claim 21, wherein the mobile station receives cell size based limitations.

29. The wireless communication system of claim 28, wherein the cell size based limitations are embedded in overheads or other messages.

30. The wireless communication system of claim 21, wherein the results of phase measurements are input to position location algorithms.

31. A method of improving geo-location measurements in a wireless communication system comprising:
computing a set of parameters;
transmitting the set of parameters to a mobile station; and
modifying a geo-location search based on the set of parameters.

32. The method of claim 31, further comprising determining the speed of the mobile station.

33. The method of claim 31, further comprising using infrastructure location information to determine the parameters.

34. The method of claim 33, further comprising dividing the location information into cell sectors.

35. The method of claim 31, further comprising identifying each cell sector by number.

36. The method of claim 31, further comprising modifying search parameters when performing geo-location searches.

37. A method for modifying geo-location searches in a wireless communication system comprising:
determining a set of parameters; and
modifying a search window size and offset based on the set of parameters.

38. The method of claim 37, further comprising computing the speed of the mobile station to obtain the set of parameters.

39. The method of claim 38, further comprising determining infrastructure information to estimate neighbor timing data.

40. The method of claim 29, further comprising dividing the cell into sectors, wherein each sector has specific neighbor timing information.

41. The method of claim 37, further comprising computing the set of parameters at the base station.

42. The method of claim 37, further comprising detecting the line-of-sight path to determine the geo-location information.

43. The method of claim 37, further comprising transmitting the set of parameters to a mobile station.

44. The method of claim 43, further comprising modifying a search window based on the set of parameters when performing a geo-location search.

45. A wireless communication system comprising:
a plurality of base stations which calculate a set of parameters for geo-location searches; and
a mobile station which performs geo-location searches with one or more of the plurality of base stations, wherein the mobile station receives the parameter set from the plurality of base stations and modifies the geo-location searches based on the parameter set.

46. The wireless communication system of claim 45, wherein the mobile station further determines search window limitations by determining an earliest point in time of the window as earlier than the latest of the line-of-sight or earliest path times from a set of sectors by a cell size based factor or speed based factor.

47. The wireless communication system of claim 45, wherein the mobile station further determines search window limitations by determining a latest point in time of the window as later than the earliest of the line-of-sight or earliest path times from a set of sectors by a cell size based factor or speed based factor.

48. The wireless communication system of claim 45, wherein the mobile station modifies the geo-location search based on the speed of the mobile station.

49. The wireless communication system of claim 45, wherein the mobile station modifies the window size and offset.

50. The wireless communication system of claim 45, wherein the set of parameters incorporates infrastructure location information.

51. The wireless communication system of claim 50, wherein the infrastructure location information is divided by sectors.
